(19) United States
(12) Patent Application Publication
(10) Pub. No.: US 2009/0102672 A1
(43) Pub. Date: Apr. 23, 2009

(54) FEATURES TO REDUCE LOW-BATTERY REPORTING TO SECURITY SERVICES AT NIGHT

(75) Inventors: Tom R. Petek, Sacramento, CA (US); Kenneth L. Addy, Massapequa, NY (US); David S. Zakrewski, Babylon, NY (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 11/875,054

(22) Filed: Oct. 19, 2007

(51) Int. Cl. G08B 21/00

(52) U.S. Cl. 340/636.15

(57) ABSTRACT

A battery-powered RF sensor is provided for use in security and alarm systems for monitoring alarm state conditions, and transmitting an alarm state detection signal upon detection of an alarm state condition. The RF sensor is constructed to include an RF transmitting portion, a battery, a low-battery voltage level detection portion and a counter for periodically detecting an output voltage level of the battery, and comparing the voltage level to a first threshold voltage. If the detected battery output voltage level is determined to be less than the first threshold voltage, the low- or depleted-battery state is not immediately reported, but is reported at another time if the low-battery condition persists. That is, the low battery condition would preferably not be reported until daytime hours, other than for a dead battery condition. The reporting control is implemented by use of the low-battery voltage detection portion, which looks to a counter to determine the elapsed time since the low- or depleted-battery condition is detected. If the low- or depleted-battery condition persists until the counter counts down, the condition is automatically reported.

### BACKGROUND OF THE INVENTION

The present invention relates to centralized security and alarm systems, and more particularly relates to low-battery reporting by RF sensors, and operation under particular environmental conditions to which they may be subjected during normal central security and alarm system operation.

Conventional surveillance systems, also known as security and alarm systems, are known to include wireless or RF security sensors or devices, e.g., RF motion detectors, RF door sensors, RF window sensors, RF smoke detectors, etc. (broadly hereinafter referred to as “RF sensors”), to support wirelessly monitoring of secured areas or spaces. Conventional RF sensors communicate directly to a central panel via RF signaling, or some other type of wireless and/or air-borne signal. There are, however, newer systems that provide for a limited ability to communicate between RF sensors and the central panel bi-directionally with a central panel or controller. Known RF sensors are traditionally battery powered.

During operation with battery-powered RF sensors, a depleted battery could impair the operation of the RF sensor, and a dead battery would render the RF sensor inoperable. Known solutions for avoiding such low-battery and dead-battery conditions include providing a monitoring circuit with the RF sensor that generates a “low-battery” alarm signal, communicated to the central panel. While a detection of a depleted battery condition in an RF sensor, particularly a standalone RF sensor such as a smoke detector or CO detector, may produce an audible signal (e.g., a chirping sound), audible signals are traditionally not employed with RF sensor-based security systems. Such operation will faithfully generate a low-battery signal, and communicate the signal to the central panel whenever the capacity of the battery is unacceptable.

Whether the signal is merely a signal communicated to the central panel, or an audible signal generated to draw a owner to a standalone smoke detector that is chirping in response to a low or depleted battery condition, the signal is communicated repeatedly (generally) until the battery is replaced or until its energy output becomes insufficient to power the battery monitoring circuit. In cases where a low battery signal is not audibly communicated, but communicated electronically, the low battery state is detected, and low battery signal is communicated normally at a time at which the RF sensor is active, or is “waking up” to execute a supervisory transmission. The power budget impact of such supervisory transmissions is negligible.

Such low-battery, or depleted battery signals from an RF sensor, or a standalone smoke detector, with a dead or dying battery do provide sufficient “notice” when the RF sensor or standalone smoke detector or like devices battery needs replacement. The conventional RF sensor communicates to a central panel or central station via an RF signal at detection of the adverse battery condition, where the standalone smoke detector and like devices generate an audible notice (e.g., by a sharp beep). Such reporting or notice can be a distinct disadvantage because most low-battery reporting from RF sensors to local (central) panels, and beeping by a low-battery condition in standalone devices (smoke detectors) usually occurs in the small hours of the morning. The reason for this phenomenon is that battery output voltage is temperature dependent, and as such, drops (i.e., the battery output voltage) during the sunless hours of the night (as the temperature drops) while the sensing threshold for the low-battery detection circuit within the RF sensor circuitry is not (significantly) temperature dependent.

What would be desirable, therefore, in the field of central security and alarm system operation, is a novel, low-battery reporting feature that reduces low-battery reporting burdens to both customers and security services by delaying reporting of low-battery condition, under particular environmental conditions, until the daylight hours.

### SUMMARY OF THE INVENTION

To that end, the present invention provides a novel, battery-powered RF sensor for use in security and alarm systems for monitoring and communicating alarm state conditions. The novel RF sensor of the invention is constructed to include an RF transmitting portion, a battery, a low-battery voltage level detection portion and a counter for periodically detecting an output voltage level of the battery, and comparing the voltage level to a first threshold voltage level. If the detected battery output voltage level is determined to be less than the first threshold voltage, the low-battery voltage detection portion then determines whether the counter is active. If the counter is inactive, the counter is set, and the detected battery output voltage level is compared with a second threshold voltage level. If the detected battery output voltage level is less than the second threshold voltage level, the counter is reset and a low battery communication signal is sent.

Depending on the operating characteristics of a system in which an RF sensor of the invention is operational, supervisory transmissions (e.g., wake-up signals) may occur frequently, for example, once every hour, once every ten minutes, etc. The supervisory rate is typically mandated by regulatory requirements. As found in the prior art, low battery warnings are communicated at least one week before a projected depleted battery state (Battery death), during which the RF sensor driven by the battery could be inoperable. While a continuous counter may be used by the novel inventive operation, a preferred mode of operation would have the counter increment, decrement, or be reset each time the RF sensor wakes up.

Where the RF sensor determines that the detected battery output voltage level is less than the first threshold voltage level, but not less than the second threshold voltage, the RF sensor will not send a “change battery” or “low battery” signal (used interchangeably) unless the counter has counted down. So once the battery output voltage level falls below the first threshold voltage level, and has not dropped below the second threshold voltage level, the battery is not in a critical power state, so reporting is postponed for the count-down period, during which period environmental conditions can change such that the battery output voltage level may rise above the first threshold voltage level.

Hence, if the detected battery output voltage level rises to a voltage level that is at least the first threshold voltage before the counter counts down, the RF sensor clears the counter. Preferably, at a fixed periodic interval that is less than the count-down period, the low-battery voltage level detection portion automatically wakes to monitor or detect the battery output voltage level, The RF sensor's low-battery voltage level detection portion, however, is compelled to immediately detect the battery's output voltage level at alarm-event detections, and at tamper-event detections.

The invention also includes a novel method for monitoring low-battery state conditions within battery-powered RF sensor (“RF sensor”) comprising a security and alarm system, where the RF sensor includes a battery and a counter. The novel method includes, at a regular interval, detecting or assessing the battery's output voltage level, and comparing the detected battery output voltage level to a first designated threshold voltage level. If the detected battery output voltage level is less than the first designated threshold voltage level, the RF sensor determines whether the counter associated with the RF sensor is active. If the counter is inactive, the novel RF sensor starts/activates the counter.

If the detected battery output voltage level is less than the second designated threshold voltage level, the novel RF sensor sends or transmits a low- or depleted-battery communication signal. The low- or depleted-battery signal is wirelessly communicated, typically to a central panel, but could be transmitted for receipt by a device or receiver that is other than the central panel, depending on system design and construction. If the battery output voltage is not less than the second designated threshold voltage level, the novel method determines whether the counter has counted down, and only if so, sends the low-battery communication signal. But where the detected battery output voltage level is determined to be greater than or equal to the first designated voltage level, and the counter is actively counting down, the counter is cleared. In such case, while the battery voltage was detected below the first battery voltage threshold level, circumstances raised the voltage back to or greater than the threshold before the counter counted down. For that matter, while the count-down period may be any programmed time period, it is preferably larger in time than the time period between detecting, for example, 4 to 8 hours.

In another embodiment, the invention includes a security and alarm system for monitoring a secured location, which system includes and operates with the novel RF sensors and low-battery sensing operation. That is, the novel security and alarm system includes a central panel and at least one battery-powered RF sensor for monitoring the secured location for alarm events, and communicating with the central panel. The battery-powered RF sensor includes a battery, an RF transmitting portion, a low-battery output voltage level detection portion and a counter. During operation, the low-battery detection portion periodically detects an output voltage level of the battery and compares it to a first designated voltage threshold level, and if the detected battery output voltage level is less than the first designated voltage threshold level, comparing the battery output voltage level to a second designated voltage threshold level. If the detected battery output voltage level is less than the second threshold voltage level, a low battery communication signal is sent. Preferably, the low-battery communication signal is sent to the central panel.

If the detected battery output voltage level is less than the first designated voltage threshold level, the RF sensor determines whether the counter is active, and if not active, sets the counter, and then determines if the battery output voltage level is less than the second designated voltage threshold level. If less than the second designated voltage threshold level, the RF sensor clears the counter and sends the low-battery signal. But if the battery output voltage level is less than the first designated voltage threshold level, but greater than the second voltage threshold level, and the counter has not counted down, no signal is sent. Again, when the battery output voltage level is between the two designated voltage threshold levels, there is no low battery reporting signal sent unless the counter has counted down. And if the counter is counting down (active), and the battery voltage output level arises back above the first designated threshold voltage level, the counter is cleared and no further action taken.

In an alternative embodiment, a low-battery reporting delay may be implemented at the panel. The panel “knows” the time of day, while not necessary for inventive operation, and preferably “knows” the temperature within the building or other location of the RF sensor or standalone device. It is readily within the purview of the skilled artisan to prepare and add software/firmware to the panel in order that the system and method carry out this novel feature operation. Because the RF sensors are required to advise a low battery condition at least 1 week before the sensor or transmitter becomes non-fictional, the amount of reporting delay could be set by the installer would be limited to time periods that do not compromise the one week minimum period.

A significant advantage to implementing this feature is that the software/firmware embodying same could be retrofitted to existing legacy systems and executable applications, requiring no hardware change. Hence, the RF sensors would be unchanged. A minor disadvantage of this feature includes that the local (central) panel would not know if the battery at the RF sensor, or standalone detector device, has failed abruptly for some reason, for example, by a sudden battery failure, or by tampering with the RF sensor. Known instances of tampering with RF sensors include, for example, disabling the battery with criminal intent. Lack of supervisory transmissions from an RF sensor suffering from such sudden battery failure would eventually result in a panel “trouble” notification to the central station.

Alternatively, and in a more sophisticated embodiment, the invention implements a low-battery reporting delay at the panel by transmitting a (digital) representation of the actual battery voltage as part of the low-battery signal rather than transmitting a low-battery signal as described above. Consequently, upon receipt of the digital signal, the panel could decide if the afflicted battery decline is normal or anomalous, and take appropriate action. But the reader should note that while this alternative embodiment is a high-integrity approach, its implementation would be somewhat more complex, and more expensive than the embodiments previously discussed. The reason for the added complexity and expense for implementing same reside in the fact that changes/provisions would be required at all sensors as well as the software/firmware resident at the panel. Note that low-battery reporting delay embodied at such RF sensors and standalone devices would be readily implementable in new RF sensors, and the security systems that they might operate within. Particular users of such RF sensors and systems employing same that find such a feature preferable, however, would readily assume the additional cost for the additional value provided when considering purchasing same.

### DESCRIPTION OF THE DRAWING FIGURES

The foregoing and other objects, aspects and advantages will be better understood from the following detailed description of embodiments of the inventions, with reference to the drawings, in which:

FIG. 1 is a schematic diagram of one embodiment of a novel RF sensor of the invention;

FIG. 2 is a schematic diagram of one embodiment of a novel security and alarm system of the invention, including one or more of the RF sensors; and

FIG. 3 is a schematic flow diagram of a novel method of monitoring low-battery state conditions within battery-powered RF sensors of the invention.

### DETAILED DESCRIPTION OF THE INVENTION

The inventive battery-powered RF sensor with low battery reporting, security and alarm system including such an RF sensor, and a method for monitoring low-battery state conditions within battery-powered RF sensors (with low battery reporting ability) significantly reduces the low-battery reporting burden on security and alarm system customers, and security personnel, are set forth and described herein for the purpose of conveying the broad inventive concepts. The drawings and descriptions provided are not meant to limit the scope and spirit of the invention in any way.

Broadly, the RF sensor of the invention is constructed as discrete hardware components, or may be constructed as a custom integrated circuit or ASIC. As such, the operational control of the RF sensor and at a system level may be implemented by a micropower-configured microcontroller, or other processor, in which is present a set of computer readable instructions that when processed, carry out the inventive method for monitoring using such battery-powered RF sensors with low battery reporting.

Alternatively, low-battery reporting delay can be implemented at the panel. The panel knows time of day, and possibly even temperature within the secured location at which the novel RF sensors are employed. Hence, the skilled artisan cab readily, and easily add software/firmware to a processor at the panel to add this novel monitoring and reporting feature. RF sensors are typically required to advise the central panel of a low battery condition at least 1 week before the sensor or transmitter becomes non-functional, i.e., a dead battery condition. An amount of reporting delay could be set by the security system or RF sensor installer.

A significant advantage to this approach resides in its inherent ability to be readily retrofitted to existing systems, and system requirements, and that it is software implementable, requiring no hardware changes. The sensing and any delay before communicating the low- or depleted battery condition would occur at the central panel, as distinguished from at the RF sensor itself. In such an embodiment, the RF sensors would not need to be modified. A minor disadvantage of this approach is that the panel would not know if the battery at the RF sensor had failed abruptly for some reason. Reasons for abrupt failure include sudden battery failure and tampering with the sensor, i.e. the battery has been disabled with criminal intent. But then the lack of supervisory transmissions from that sensor would eventually result in a panel “trouble” notification to the central station.

For that matter, a more sophisticated implementation of low-battery reporting delay at the panel is possible. For example, if rather than transmitting a low-battery signal, the RF sensor transmitted a (digital) representation of the actual battery voltage, then the panel could decide if battery decline is normal or anomalous. This is a high-integrity approach, but it is the most complex and expensive to implement. The expense is associated with any changes or provisions that would be required at all of the RF sensors comprising such a system of sensors and in the firmware driving a processor at the central panel. The low-battery reporting delay embodied at the RF sensor would still nevertheless realize intrinsic value for new products as a sales advantage for RF sensors and the related system utilizing the novel RF sensor low-battery, or depleted battery operation.

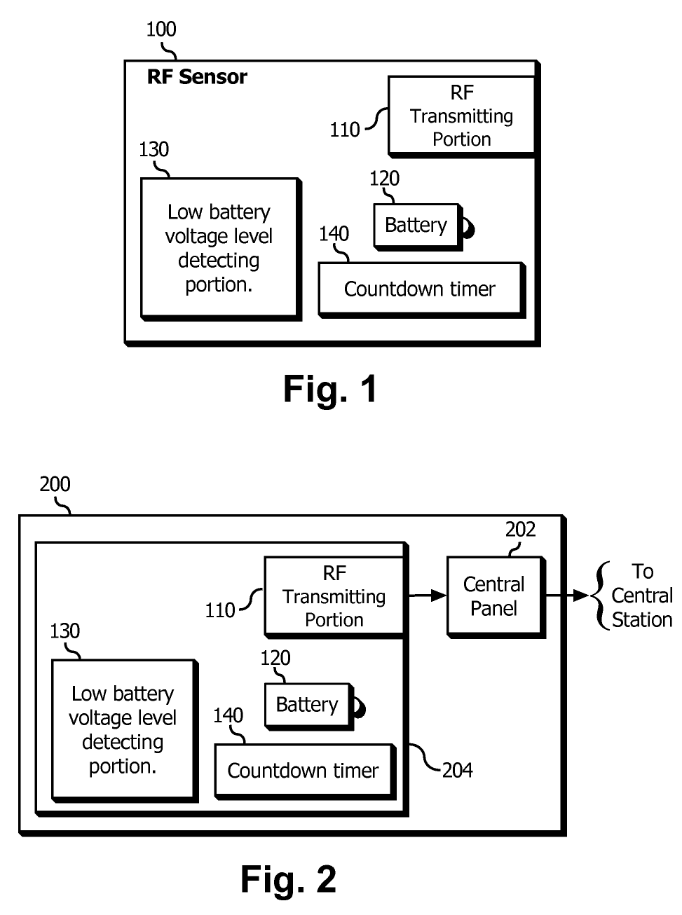

FIG. 1 herein depicts one embodiment of a battery-powered RF sensor 100 for monitoring alarm state conditions, and transmitting an alarm state detection signal where an alarm state condition is detected. RF sensor 100 further includes the low battery monitoring and reporting feature of the invention, and includes an RF transmitting portion 110, a battery 120, a low-battery voltage level detection portion 130, and a counter 140. The low-battery voltage level detection portion 130 periodically wakes and detects an output voltage level of the RF sensor battery 120, and compares the detected battery output voltage level to a first designated threshold voltage level.

If the detected battery output voltage level is determined to be less than the first threshold voltage level, the battery is in normal decline (predictably linear), from which threshold level several days or weeks of fully-powered operation might still be anticipated. That is, the voltage drop from the first threshold level can be quite gradual, taking days, but most probably weeks to decline to the critical, or second lower voltage threshold level. The lower, or second threshold voltage level is typically chosen to detect sudden battery failure, an acute danger that the battery has insufficient power to drive the RF sensor 100. But because, as mentioned, a battery voltage drop slightly below a required battery voltage threshold level is likely to occur at night, during which lower temperatures tend to lead to lowered battery output voltages, it is inconvenient if not absolutely necessary to change the battery, and under certain conditions may await morning. For one, waiting until daylight, or business hours, is less inconvenient to both end-users and monitoring stations, and with the sunlight, and concomitant rising daylight temperatures, the battery output voltage may rise to an acceptable level.

So in this case where the battery's output voltage has dropped below the first battery voltage threshold level, the low-battery voltage level detection portion 130 determines whether the counter 140 is active. If not, the counter is set to provide a time period in which the battery's (120) output voltage may exist below the first (fixed) threshold voltage level, but below a second fixed or designated battery voltage threshold level. The low-battery voltage level detection portion then compares the detected battery output voltage level to the second threshold voltage level. If the detected battery output voltage level is less than the first threshold voltage level, but still above or greater than the second threshold voltage level, a low battery communication signal is not sent unless the counter 140 has timed out.

But if the detected battery output voltage level is less than the first threshold voltage level, and less than the second threshold voltage level, a low battery communication signal is automatically sent, regardless of whether the counter 140 has counted down. The counter is automatically cleared. As such, the novel RF sensor 100 requires or operates with two designated first and second low voltage threshold levels. The first or higher voltage threshold level is for traditional battery voltage level sensing, which is used to identify those RF sensor battery 120, whose output voltage levels are getting low, and likely needing replacement over the next several days or several weeks. The second or lower voltage threshold level is crossed when the battery's power is “critically low,” and immediate attention (replacement) is required. This second or lower voltage threshold is particularly important in cases where an RF sensor's battery fails abruptly, as opposed to gradual depletion of the battery's resources.

During normal security and alarm system operation, the novel RF sensors (100) “wake up” at regular intervals to send supervisory signals, as well as being woken up or awakened by alarm and tamper events. The battery voltage checking is done during those “awake” periods in accordance with the novel method, and system operation including the RF sensors. When a low-battery condition is initially detected two paths can be taken. If only the higher threshold has been crossed, then a 4 to 8 hour counter is started. The reader and skilled artisan should note, however, that the counter may be set for any count-down period without deviating from the scope and spirit of the invention. That counter continues to count down while the first or higher voltage threshold remains crossed during subsequent checks. But if the first or higher designated voltage threshold level is found satisfied (not below the first designated voltage threshold level) at any cycle or wake-up period, then the count-down counter is reset or cleared. This has the effect of filtering out very brief dips in battery voltage below the first voltage threshold level wherein low battery reporting is not carried out. Only if the battery's (120) voltage level is between the first and second designated voltage threshold levels, and the counter 140 runs out will a low-battery signal is sent. If the second or lower designated voltage threshold level has been crossed will a low-battery signal be immediately sent.

FIG. 2 herein depicts a security and alarm system 200 for monitoring a secured location, which system includes a novel RF sensor 204, with low battery reporting ability of this invention. The security and alarm system 200 includes a central panel 202, and the at least one battery-powered RF sensor 204 as shown, for monitoring the secured location for alarm events, and communicating with the central panel 202 wirelessly. If a true low battery condition is determined in a battery 120 powering the at least one RF sensor, the RF senor 204 sends a low battery signal to the central panel, which may then issue a local advisory that maintenance at the RF senor is needed, that the battery in the RF sensor must be replaced, and/or notify security personnel at a central monitoring location (central station) of the detected condition.

That is, the battery-powered RF sensor 204 includes a battery 120, an RF transmitting portion 110, a low-battery output voltage level detection portion 130, and a counter 140. During operation, the low-battery detection portion 110 periodically detects an output voltage level of the battery 120, and compares it to a first designated voltage threshold level, and if the detected battery output voltage level is less than the first designated voltage threshold level, the low-battery detection portion 110 compares the voltage level to a second designated voltage threshold level.

If the detected battery output voltage level is less than the second threshold voltage level, a low battery communication signal is sent. Preferably, the low-battery communication signal is sent to the central panel 202, but is not limited to communicating with only the control or central panel. For that matter, the signal could be sent to the central panel 202, or to a central station (not shown), via a repeater, or multiple repeaters (not shown), which may be included in the system to maintain the strength of the transmitted signal.

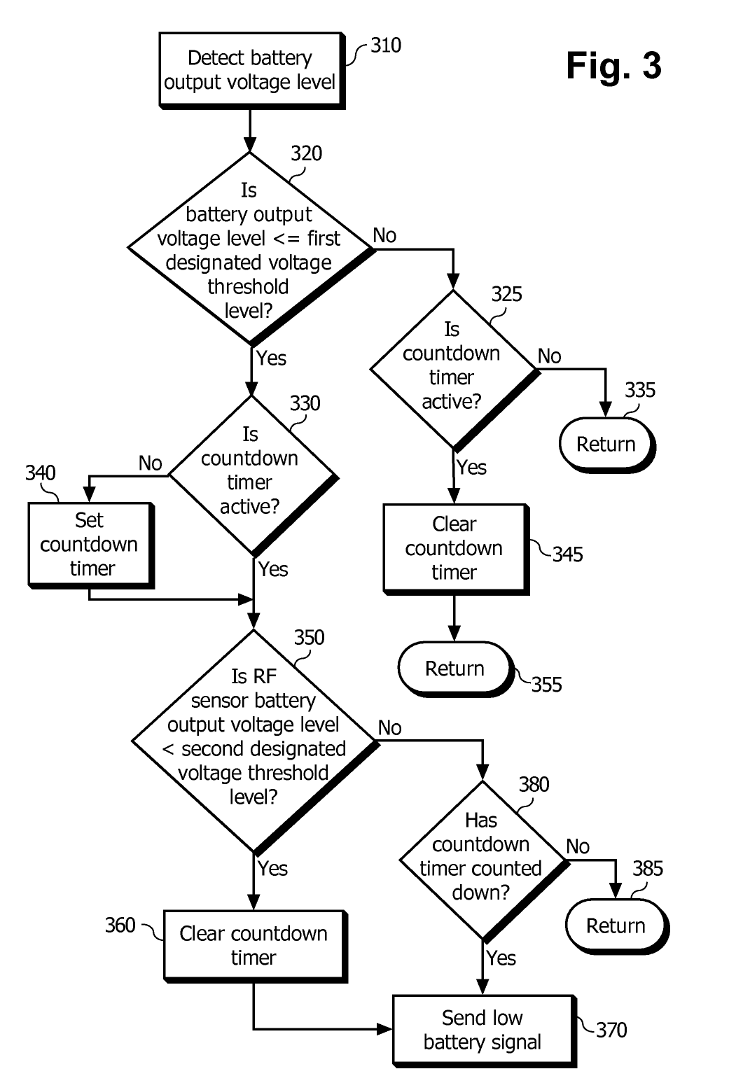

For that matter, FIG. 3 herein depicts one embodiment of a method for monitoring (300) low-battery state conditions within a battery-powered RF sensor (“RF sensor”) comprising a security and alarm system, wherein the RF sensor includes a battery electrically connected to power the RF sensor, and a counter. The novel monitoring method 300 includes, at a regular interval, a first step in which the RF sensor is awaken or called upon to detect or assess an output voltage level of the RF sensor battery, as represented by block 310. The detected battery output voltage level is then compared to a first designated voltage threshold level in a step represented by decision block or diamond 320. If the detected output voltage level is less than the first designated voltage level (Yes), the method provides that the RF sensor determines whether the counter associated with the RF sensor is active, as represented by decision block or diamond 330.

If the counter is not active (No), the method requires that the novel RF sensor sets the counter in a step represented by block 340. If the counter is active, the novel method carries out a step of comparing the detected battery output voltage level with a second designated voltage level, as represented by decision block or diamond 350. If the detected output voltage level is less than the second designated voltage level, the method carries out a step of clearing the counter, as represented by block 360. The method then automatically sends a low battery communication signal, in a step represented by block 370.

But where the output of decision block 350 is No (the battery output voltage level is determined to be not less than the second designated voltage level), the method carries out a step where the it is determined whether the counter has counted down, as represented by the decision block or diamond 380. If it is determined that the counter has not counted down (No) in decision step 380, the method loops, as represented by return block 385. But if it is determined in decision step 380 that the counter has counted down (Yes), the process flow carries out the step represented by block 370, by sending the low-battery communication signal.

But if the detected battery output voltage level is determined to not be less than the first designated battery voltage threshold level in the step represented by block or decision diamond 320, the method carries out a step of determining whether the counter is active, as represented by the decision block or diamond 325. If not (No), the method loops or returns, as represented by block 335. But if the counter is active, a step of clearing the counter is executed, as represented by decision block 345, and the program returns (block 355). While the count-down period of the counter may be any programmed time period, the period is preferred to be larger in time than the period between detecting, for example, 4, 8, 12 hours, etc.

While it is apparent that the invention herein disclosed is well calculated to fulfill the objects stated above, it will be appreciated that numerous modifications and embodiments may be devised by those skilled in the art and it is intended that the appended claims cover all such modifications and embodiments as fall within the true spirit and scope of the present invention. For that matter, the invention has been described herein with reference to particular exemplary embodiments. Certain alterations and modifications may be apparent to those skilled in the art, without departing from the scope of the invention.

1. A method for monitoring low-battery state conditions within a battery-powered RF sensor (“RF sensor”) included within a security and alarm system, the RF sensor including a battery electrically connected to power the RF sensor, and a counter, the method comprising the steps of:
at a regular interval, detecting an output voltage level of the battery; and
comparing the detected battery output voltage level to a first designated voltage threshold level;
wherein, if the detected battery output voltage level is less than the first designated voltage threshold level, comparing the detected battery output voltage level to a second designated voltage threshold level, and
wherein,
if the detected battery output voltage level is not less than the second designated voltage threshold level, determining whether the counter associated with the RF sensor is active, and has counted down; and
if the counter is active, sending a low battery communication signal if the counter has counted down, otherwise, setting the counter to begin counting down; and
wherein,
if the detected battery output voltage level is less than the second designated voltage threshold level, sending the low battery communication signal.

2. The method for monitoring as set forth in claim 1, wherein, if the detected battery output voltage level is less than the designated first voltage threshold level, and the counter is active, resetting the active counter.

3. The method for monitoring as set forth in claim 1, wherein if the detected output voltage level is not less than the first designated voltage threshold level:
determining whether the counter is active,
wherein,
if the counter is active, clearing the counter.

4. The method for monitoring as set forth in claim 1, wherein a count-down period of the counter is user adjustable.

5. The method for monitoring as set forth in claim 1, wherein a countdown period of the counter is a first countdown period during daytime hours, and a second countdown period during nighttime hours.

6. The method for monitoring as set forth in claim 1, wherein the detecting and comparing are controlled by the central panel.

7. A battery-powered RF sensor for monitoring alarm state conditions and transmitting an alarm state detection signal upon detection of an alarm state condition, the RF sensor comprising:
an RF transmitting portion;
a battery;
a counter;
a low-battery voltage level detection portion for periodically detecting an output voltage level of the battery, and comparing the battery output voltage level to a first designated threshold voltage level,
wherein, if the detected battery output voltage level is less than the first designated voltage threshold level, comparing the detected battery output voltage level to a second designated voltage threshold level, and
wherein,
if the detected battery output voltage level is not less than the second designated voltage threshold level, determining whether the counter associated with the RF sensor is active, and has counted down; and
if the counter is active, sending a low battery communication signal if the counter has counted down, otherwise, setting the counter to begin counting down; and
wherein,
if the detected battery output voltage level is less than the second designated voltage threshold level, sending the low battery communication signal.

8. The RF sensor as set forth in claim 7, wherein, if the detected battery output voltage level is less than the designated first voltage threshold level, and the counter is active, resetting the active counter.

9. The RF sensor as set forth in claim 7, wherein if the detected output voltage level is not less than the first designated voltage threshold level:
determining whether the counter is active,
wherein,
if the counter is active, clearing the counter.

10. The RF sensor as set forth in claim 7, wherein said low-battery voltage level detection portion, at a fixed periodic interval, automatically detects the battery output voltage level.

11. The RF sensor as set forth in claim 10, wherein the fixed periodic interval is less than a countdown time for the counter.

12. The RF sensor as set forth in claim 7, wherein the periodic testing by the low-battery voltage level detection portion occurs only during fixed, periodic self-test periods.

13. The RF sensor as set forth in claim 12, wherein the fixed, periodic self-test periods further include that the RF sensor sends supervisory signals.

14. The RF sensor as set forth in claim 7, wherein the low-battery voltage level detection portion is compelled to immediately detect the RF sensor battery's output voltage level at alarm-event detections, and at tamper-event detections.

15. The RF sensor as set forth in claim 7, wherein a countdown period of the counter is user adjustable.

16. The method for monitoring as set forth in claim 7, wherein the detecting and comparing are controlled by the central panel.

17. A security and alarm system for monitoring a secured location, comprising:
a central panel; and
at least one battery-powered RF sensor for monitoring the secured location for alarm events, and communicating with the central panel, wherein the battery-powered RF sensor comprises:
a battery;
an RF transmitting portion;
a low-battery output voltage level detection portion; and
a counter’
wherein the low-battery detection portion periodically detects an output voltage level of the battery and compares it to a first designated voltage threshold level, and if the detected battery output voltage level is less than the first designated voltage threshold level, comparing the voltage level to a second designated voltage threshold level,
wherein, if the detected battery output voltage level is less than the second threshold voltage level, sending a low battery communication signal.

18. The security and alarm system as set forth in claim 17, wherein the low-battery communication signal is sent to the central panel.

19. The security and alarm system as set forth in claim 18, wherein upon receipt of the low-battery communication signal is received by the central panel, the central panel forwards the signal to a central monitoring location.

20. The security and alarm system as set forth in claim 18, further including generating an audible alarm to indicate that the battery requires replacement.

21. The security and alarm system as set forth in claim 17, wherein if the detected battery output voltage level is less than the first designated voltage threshold level, determining whether the counter is active, and if not active, setting the counter.

22. The security and alarm system as set forth in claim 17, wherein if the detected battery output voltage level is less than the second designated voltage threshold level, clearing the counter and sending a low-battery communication signal.

23. The security and alarm system as set forth in claim 17, wherein if the detected battery output voltage level is not less than the first designated voltage threshold level, determining whether the counter is active, and if active, clearing the counter.

24. The security and alarm system as set forth in claim 17, wherein the low-battery detecting portion is located at the central panel.

25. A computer program product, comprising:
a tangible storage medium readable by a processing circuit and storing instructions for execution by the processing circuit for performing a method for monitoring low-battery state conditions within a battery-powered RF sensor (“RF sensor”) comprising a security and alarm system, the RF sensor including a battery electrically connected to power the RF sensor, and a counter, wherein the method comprises the steps of:
at a regular interval, detecting an output voltage level of the battery; and
comparing the detected battery output voltage level to a first designated voltage threshold level;
wherein, if the detected output voltage level is less than the first designated voltage threshold level, determining whether a counter associated with the RF sensor is active,
wherein, if the counter is inactive, setting the counter,
wherein, if the counter is active, comparing the detected output voltage level with a second designated voltage threshold level; and
wherein, if the detected battery output voltage level is less than the second designated voltage threshold level, clearing the counter and sending a low battery communication signal.

26. The computer program product as set forth in claim 25, further comprising a real-time clock, wherein, if the counter is active, if the detected battery output voltage level is less than the second designated voltage level, and a real time indicated by the real-time clock is between 2200 and 0600, sending the low battery communication signal only after the counter is determined to have counted down.

27. The computer program product as set forth in claim 25, wherein the detecting and comparing are controlled by the central panel.

28. A method for monitoring low-battery state conditions within a battery-powered RF sensor (“RF sensor”) included within a security and alarm system, the RF sensor including a battery electrically connected to power the RF sensor, the method comprising the steps of:
at a regular time interval, detecting an output voltage level of the battery; and
comparing the detected battery output voltage level to a first designated voltage threshold level;
wherein, if the first detected battery output voltage is less that the first designated voltage threshold level, determining how long the detected battery output voltage has been below said threshold voltage; and
wherein if less than a critical time period, taking no action unless the detected battery output voltage level is less than the second designated voltage threshold level, in which case sending the low battery communication signal.
